(19) United States
(12) Patent Application Publication
(10) Pub. No.: US 2019/0104335 A1
(43) Pub. Date: Apr. 4, 2019

(54) THEATER EARS AUDIO RECOGNITION & SYNCHRONIZATION ALGORITHM

(71) Applicant: Theater Ears, LLC, Boca Raton, FL (US)

(72) Inventor: Vineet Kashyap, New Delhi (IN)

(21) Appl. No.: 15/720,180

(22) Filed: Sep. 29, 2017

(51) Int. Cl. H04N 21/43; G11B 27/10; H04N 21/439; G06F 17/30; H04N 21/41

(52) U.S. Cl. CPC H04N 21/4307; G11B 27/10; H04N 21/4126; G06F 17/30743; H04N 21/4394

(57) ABSTRACT

The goal of the audio recognition and synchronization algorithm is to obtain the timestamp (start) of a smaller microphone recorded audio track in a larger (original/unmodified) audio track and to synchronize with the second language track based on the timestamp retrieved. In order to get the position of recorded audio track in original track we first generate a finger print of the original audio track. Next, we run a similar process for the recorded track to generate a second finger print. Given the finger print of the original audio track and the recorded audio track (created above) we can detect the timestamp of the recorded audio track in the original audio track. This is accomplished by matching the frequencies in the finger prints and checking if these frequencies correspond in time. Finally, we apply a detection algorithm to get the timestamp.

### BACKGROUND OF THE INVENTION

### Field of the Invention

The present disclosure is related to the field of audio processing technology and more particularly to audio recognition and synchronization.

### Description of the Related Art

The use of audio “finger prints” has been known in the art, and was partly pioneered by such companies as Arbitron for audience measurement research. Audio signatures are typically formed by sampling and converting audio from a time domain to a frequency domain, and then using predetermined features from the frequency domain to form the signature.

While audio signatures have proven to be effective at determining exposures to specific media, they can be computationally taxing, and further require databases of thousands, if not millions of audio signatures related to specific songs. In the context of this invention, there exists a need for the background audio in a movie spoken in “language A” to be compared to the background audio of the same movie spoken in “language B”. Using audio “finger prints”, it is possible to detect similarities between the two mentioned audio tracks and thus synchronize them.

### BRIEF SUMMARY OF THE INVENTION

Embodiments of the present invention address deficiencies of audio processing in respect to the recognition and synchronization of audio and provide a novel and non-obvious method, system and algorithm for audio recognition and synchronization. In an embodiment of the invention, an algorithm for audio recognition and synchronization includes a method that utilizes sound data information including frequency and intensity to assist with audio recognition and synchronization. The method includes generating a finger print that stores time, frequency and intensity data. The method yet further includes comparing frequency data from the finger prints of two audio files to detect if the data temporally corresponds.

For example, an audio synchronization method may include storing an audio track in memory of a computer device, activating audio synchronization of the stored audio track with playback of a contemporaneously acquired audio signal, computing an audio-frequency graph for the stored audio track and also computing an audio-frequency graph for the contemporaneously acquired audio signal, comparing the graphs to identify similar data points, locating a timestamp corresponding to the similar data points and playing back the stored audio track from a position corresponding to the located timestamp.

In one aspect of the embodiment, the comparison of the graphs includes converting each of the graphs into a separate fingerprint and identifying the similar data points in the separate fingerprints. In another aspect of the embodiment, the graphs are spectrograms. In another aspect of the embodiment, the fingerprints are each two-dimensional arrays generated with maximum frequencies at a given time for both the stored audio track and the contemporaneously acquired audio signal. In yet another aspect of the embodiment, the computer device is a mobile phone. Finally, in even yet another aspect of the embodiment, the identification of the similar data points occurs by overlaying the graphs, detecting a diagonal line in the overlain graphs, computing an equation for the diagonal line, extending the diagonal line across a Y-axis of the overlain graphs, and locating an intercept of the diagonal line with the Y-axis, the intercept determining the timestamp.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for recognizing and synchronizing audio;

FIG. 2 is a schematic illustration of a data processing system configured for an audio recognition and synchronization method; and,

FIG. 3 is a flow chart illustrating a process for recognizing and synchronizing audio.

### DETAILED DESCRIPTION OF THE INVENTION

Embodiments of the invention provide for a method for audio recognition and synchronization. In accordance with an embodiment of the invention, a data processing system can determine where two audio files synchronize with regard to time.

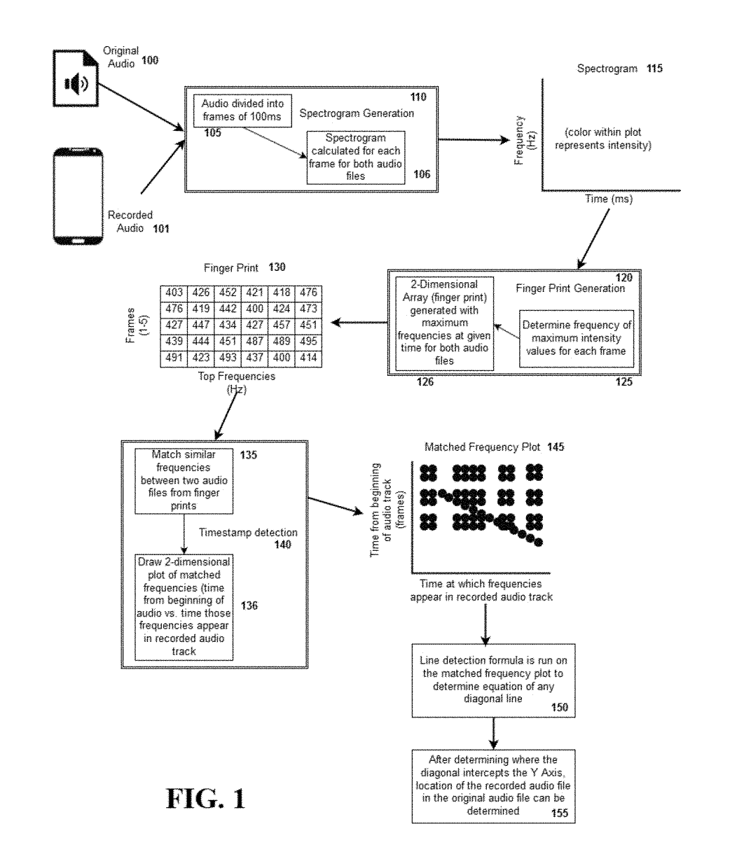

In further illustration, FIG. 1 pictorially shows a process for audio recognition and synchronization. As shown in FIG. 1, an original audio track 100 and a recorded audio track 101 go through a spectrogram generation process 110. Each of the audio files 100 and 101 have their audio divided into frames of 100 milliseconds per process 105 before a spectrogram 115 is calculated for each frame in process 106. In finger print generation 120, the spectrogram 115 provides frequency data 125 to produce a 2-dimensional array 126 consisting of the maximum frequencies per frame, per a spectrogram 115. Thereafter, timestamp detection 140 begins when similar frequencies from finger print 130 of both audio files are matched against each other in process 135 before the matched frequencies are plotted in process 136. The matched frequency plot 145 consists of two axes: frames since the beginning of the audio track, and time at which frequencies appear in the recorded audio track. Any diagonal line formed by the matched frequencies indicates a temporal relationship, so a line detection formula 150 is run by the program to determine the equation of the diagonal line. The program then determines where the diagonal line intercepts the Y Axis in process 155. With this information, the program can synchronize the two audio tracks.

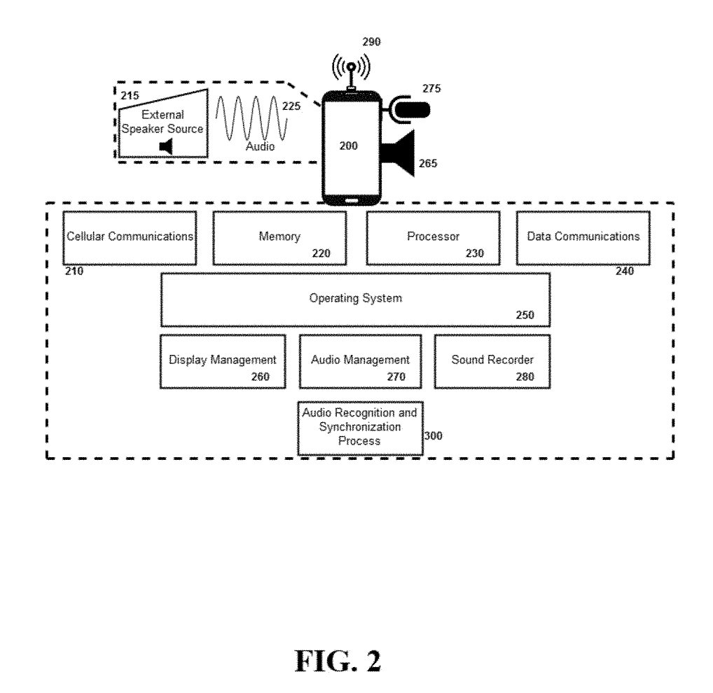

The process described in connection with FIG. 1 can be implemented in a data processing system. In further illustration, FIG. 2 schematically shows a data processing system configured for audio recognition and synchronization. The system can include a mobile device 200, for instance a smart phone, tablet computer or personal digital assistant. The mobile device 200 can include at least one processor 230 and memory 220. The mobile device 200 additionally can include cellular communications circuitry 210 arranged to support cellular communications in the mobile device 200, as well as data communications circuitry 240 arranged to support data communications.

An operating system 250 can execute in the memory 220 by the processor 230 of the mobile device 200 and can support the operation of a number of computer programs, including a sound recorder 280. Further, a display management program 260 can operate through the operating system 250 as can an audio management program 270. Of note, an audio recognition and synchronization module 300 can be hosted by the operating system 250. The audio recognition and synchronization module 300 can include program code that, when executed in the memory 220 by the operating system 250, can act to determine the timestamp of external audio 225 emitted from external speaker source 215.

In this regard, the program code of the audio recognition and synchronization module 300 is enabled to determine the frequency and intensity of an audio track 225 at a given time utilizing a microphone 275. The program code of the audio recognition and synchronization module is able to match the frequencies of two audio tracks to determine where the two files temporally match each other.

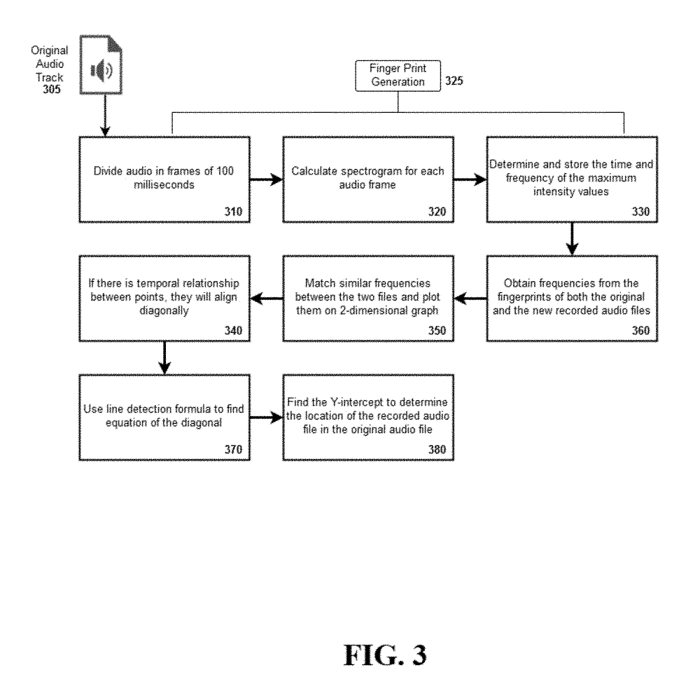

In even yet further illustration of the operation of the audio recognition and synchronization module 300, FIG. 3 is a flow chart illustrating a process for audio recognition and synchronization. An original audio track 305 first goes through a finger print generation process 325 in which audio from track 305 is divided into frames of 100 milliseconds in process 310. A spectrogram is then calculated for each frame in process 320 before the time, frequency and intensity is determined and stored in process 330. Thereafter, the program obtains frequencies from the finger prints of both audio files in process 360 before similar frequencies between the two files are matched and plotted on a 2-dimensional graph in process 350. In block 340, the program detects any temporal relationship between the frequencies in the form of a diagonal line. Line detection 370 is utilized to determine where the diagonal intercepts the Y Axis in block 380. After this process is complete, the program has the information necessary to synchronize the two audio tracks.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. An audio synchronization method comprising:
storing an audio track in memory of a computer device;
activating audio synchronization of the stored audio track with playback of a contemporaneously acquired audio signal;
computing an audio-frequency graph for the stored audio track and also computing an audio-frequency graph for the contemporaneously acquired audio signal;
comparing the graphs to identify similar data points;
locating a timestamp corresponding to the similar data points; and, playing back the stored audio track from a position corresponding to the located timestamp.

2. The method of claim 1, wherein the comparison of the graphs comprises converting each of the graphs into a separate fingerprint and identifying the similar data points in the separate fingerprints.

3. The method of claim 1, wherein the graphs are spectrograms.

4. The method of claim 1, wherein the fingerprints are each two-dimensional arrays generated with maximum frequencies at a given time for both the stored audio track and the contemporaneously acquired audio signal.

5. The method of claim 1, wherein the computer device is a mobile phone.

6. The method of claim 1, wherein the identification of the similar data points occurs by overlaying the graphs, detecting a diagonal line in the overlain graphs, computing an equation for the diagonal line, extending the diagonal line across a Y-axis of the overlain graphs, and locating an intercept of the diagonal line with the Y-axis, the intercept determining the timestamp.

7. A computer program product for audio synchronization, the computer program product including a computer readable storage medium having program instructions embodied therewith, the program instructions executable by a device to cause the device to perform a method including:
storing an audio track in memory of a computer device;
activating audio synchronization of the stored audio track with playback of a contemporaneously acquired audio signal;
computing an audio-frequency graph for the stored audio track and also computing an audio-frequency graph for the contemporaneously acquired audio signal;
comparing the graphs to identify similar data points;
locating a timestamp corresponding to the similar data points; and,
playing back the stored audio track from a position corresponding to the located timestamp.

8. The computer program product of claim 7, wherein the comparison of the graphs comprises converting each of the graphs into a separate fingerprint and identifying the similar data points in the separate fingerprints.

9. The computer program product of claim 7, wherein the graphs are spectrograms.

10. The computer program product of claim 7, wherein the fingerprints are each two-dimensional arrays generated with maximum frequencies at a given time for both the stored audio track and the contemporaneously acquired audio signal.

11. The computer program product of claim 7, wherein the computer device is a mobile phone.

12. The computer program product of claim 7, wherein the identification of the similar data points occurs by overlaying the graphs, detecting a diagonal line in the overlain graphs, computing an equation for the diagonal line, extending the diagonal line across a Y-axis of the overlain graphs, and locating an intercept of the diagonal line with the Y-axis, the intercept determining the timestamp.
